(19) United States
(12) Patent Application Publication
(10) Pub. No.: US 2017/0246637 A1
(43) Pub. Date: Aug. 31, 2017

(54) THERMAL CYCLE DEVICE AND THERMAL CYCLE METHOD

(71) Applicant: Seiko Epson Corporation, Tokyo (JP)

(72) Inventor: Yuji SAITO, Shiojiri (JP)

(21) Appl. No.: 15/435,632

(22) Filed: Feb. 17, 2017

(30) Foreign Application Priority Data
Feb. 26, 2016 (JP) 2016-035642

(51) Int. Cl. B01L 7/00

(52) U.S. Cl. CPC B01L 7/525; B01L 2300/0654; B01L 2300/1805

(57) ABSTRACT

A thermal cycle device includes a mounting section capable of mounting a reaction vessel having a flow path that forms a circular ring or a part of a circular ring in which a reaction solution moves; a first heating section capable of heating a first region of the reaction vessel to a first temperature; and a drive mechanism that switches the reaction vessel between a first disposition and a second disposition. The first disposition is a disposition in which the first region is the lowermost portion of the reaction vessel in a direction in which gravity acts. The second disposition is a disposition in which a second region different from the first region of the reaction vessel is the lowermost portion of the reaction vessel in the direction in which gravity acts.

### CROSS-REFERENCE TO RELATED APPLICATION

This application claims the benefit of Japanese Patent Application No. 2016-035642, filed on Feb. 26, 2016. The content of the aforementioned application is incorporated herein by reference in its entirety.

### BACKGROUND

1. Technical Field

The present invention relates to a thermal cycle device and a thermal cycle method.

2. Related Art

Currently, simple test kits for rapidly performing diagnosis of infectious diseases represented by influenza using a specimen such as nasal cavity swabs are widely used. Many of them utilize an immunochromatography method, but in a case of performing a more precise test, a Polymerase Chain Reaction (PCR) method is effective.

For example, a device, which includes a tube that is formed in a spiral shape extending in a Z-axis direction that is a vertical direction while drawing a circle in an XY plane and two heat blocks having different temperatures which are disposed so as to be parallel to each other at positions facing each other in the XY plane, and performs PCR by repeating a temperature cycle in a process in which a PCR solution flows downward from a top according to gravity within the tube, is described in JP-A-2015-6139.

However, in the technique described in JP-A-2015-6139, if the number of temperature cycles to be applied is increased, it is necessary to lengthen a flow path by that amount and the device may become large in size.

### SUMMARY

An advantage of some aspects of the invention is to provide a thermal cycle device capable of being downsized. Another advantage of some aspects of the invention is to provide a thermal cycle method capable of downsizing a device.

A thermal cycle device according to an aspect of the invention includes a mounting section capable of mounting a reaction vessel having a flow path that forms a circular ring or apart of a circular ring in which a reaction solution moves; a first heating section capable of heating a first region of the reaction vessel to a first temperature; and a drive mechanism that switches the reaction vessel between a first disposition and a second disposition. The first disposition is a disposition in which the first region is the lowermost portion of the reaction vessel in a direction in which gravity acts. The second disposition is a disposition in which a second region different from the first region of the reaction vessel is the lowermost portion of the reaction vessel in the direction in which gravity acts.

In the thermal cycle device, for example, a temperature cycle can be applied to the reaction solution only by rotating the reaction vessel. Therefore, in the thermal cycle device, even if the number of times of temperature cycles to be applied is increased, the device does not become large and it is possible to achieve downsizing of the device.

In the thermal cycle device according to the aspect of the invention, the reaction vessel may be filled with the reaction solution and a liquid immiscible with the reaction solution.

In the thermal cycle device with this configuration, it is possible to hold the reaction solution in a droplet state in the liquid.

In the thermal cycle device according to the aspect of the invention, a specific gravity of the reaction solution may be greater than a specific gravity of the liquid.

In the thermal cycle device with this configuration, it is possible to position the reaction solution at the lowermost portion of the reaction vessel always in the direction in which gravity acts. Therefore, in the thermal cycle device, for example, when the liquid or the like is injected, even if air bubbles are mixed in the reaction vessel, the air bubbles having a specific gravity smaller than that of the liquid move to an uppermost portion of the reaction vessel in the direction in which gravity acts. Therefore, it is possible to reduce possibility that the reaction solution comes into contact with the air bubbles. Therefore, in the thermal cycle device, it is possible to suppress that the PCR is inhibited by the air bubbles.

In the thermal cycle device according to the aspect of the invention, a second heating section capable of heating the second region to a second temperature different from the first temperature may be further included.

In the thermal cycle device with this configuration, the first region of the reaction vessel can be heated to a temperature suitable for denaturation and the second region of the reaction vessel can be heated to a temperature suitable for annealing and extension reaction.

In the thermal cycle device according to the aspect of the invention, a fluorescence detection section that detects fluorescence of the reaction solution may be further included.

In the thermal cycle device with this configuration, it is possible to determine the number of times of temperature cycles of the PCR based on a detection result of a fluorescence detection section.

In the thermal cycle device according to the aspect of the invention, the drive mechanism may rotate the reaction vessel around a rotation axis having a component in a direction perpendicular to a direction in which gravity acts.

In the thermal cycle device with this configuration, it is possible to move the reaction solution using gravity.

In the thermal cycle device according to the aspect of the invention, the drive mechanism may process the reaction vessel.

In the thermal cycle device with this configuration, since the reaction vessel and the heating sections do not rotate, it is possible to reduce possibility that wiring for heating the heating sections is twisted and it is possible to facilitate wiring routing without using a contact point.

In the thermal cycle device according to the aspect of the invention, the reaction solution may contain nucleic acid.

In the thermal cycle device with this configuration, it is possible to amplify nucleic acid by the PCR.

A thermal cycle method according to another aspect of the invention includes switching a reaction vessel having a flow path that forms a circular ring or a part of a circular ring in which a reaction solution moves from a first disposition to a second disposition; and switching the reaction vessel from the second disposition to the first disposition. The first disposition is a disposition in which a first region of the reaction vessel is the lowermost portion of the reaction vessel in a direction in which gravity acts. The second disposition is a disposition in which a second region different from the first region of the reaction vessel is the lowermost portion of the reaction vessel in the direction in which gravity acts.

In the thermal cycle method, for example, a temperature cycle can be applied to the reaction solution only by rotating the reaction vessel. Therefore, in the thermal cycle method, even if the number of times of temperature cycles is increased, the device does not becomes large and it is possible to achieve downsizing of the device.

### BRIEF DESCRIPTION OF THE DRAWINGS

The invention will be described with reference to the accompanying drawings, wherein like numbers reference like elements.

FIG. 1 is a front view schematically illustrating a thermal cycle device according to an embodiment.

FIG. 2 is a side view schematically illustrating the thermal cycle device according to the embodiment.

FIG. 3 is a sectional view schematically illustrating the thermal cycle device according to the embodiment.

FIGS. 4A-4C are schematic views describing a thermal cycle method using the thermal cycle device according to the embodiment.

FIG. 5 is a flow chart describing the thermal cycle method using the thermal cycle device according to the embodiment.

FIG. 6 is a front view schematically illustrating a thermal cycle device according to a first modification example of the embodiment.

FIGS. 7A-7C are schematic views describing a thermal cycle method using the thermal cycle device according to the first modification example of the embodiment.

FIGS. 8A-8C are schematic views describing a thermal cycle method using a thermal cycle device according to a second modification example of the embodiment.

### DESCRIPTION OF EXEMPLARY EMBODIMENTS

Hereinafter, preferred embodiments of the invention will be described with reference to the drawings. Moreover, the embodiments described below do not unduly limit the contents of the invention described in the appended claims. In addition, all of the configurations described below are not necessarily indispensable constitutional requirements of the invention.

### 1. Thermal Cycle Device

### 1.1 Configuration

First, a thermal cycle device according to the embodiment will be described with reference to the drawings.

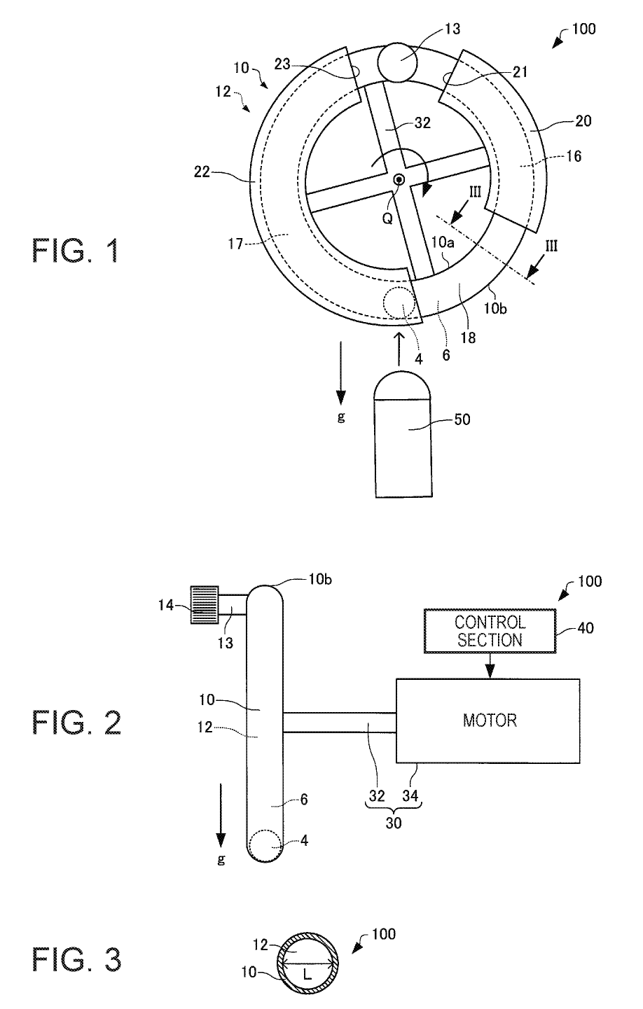

FIG. 1 is a front view schematically illustrating a thermal cycle device 100 according to the embodiment. FIG. 2 is aside view schematically illustrating the thermal cycle device 100 according to the embodiment. FIG. 3 is a sectional view of line III-III of FIG. 1 schematically illustrating the thermal cycle device 100 according to the embodiment. Moreover, in FIGS. 1 and 2, and FIGS. 4A-4C, 6, 7A-7C, and 8A-8C described later, a direction in which gravity acts (hereinafter, also referred to as “gravity action direction”), that is, a downward direction is indicated by arrow g.

As illustrated in FIG. 1, the thermal cycle device 100 includes heating sections 20 and 22 capable of mounting a reaction vessel 10, a drive mechanism 30, a control section 40, and a fluorescence detection section 50. FIG. 1 illustrates a state where the reaction vessel 10 is fixed to the heating sections 20 and 22. Moreover, for the sake of convenience, the control section 40 is not illustrated in FIG. 1. In addition, the fluorescence detection section 50 is not illustrated in FIG. 2.

The reaction vessel 10 is filled with a reaction solution 4 and a liquid 6. The reaction solution 4 is held in a droplet state in the liquid 6 . Since the reaction solution 4 has the specific gravity greater than that of the liquid 6, for example, the reaction solution 4 is positioned in the region of the lowermost portion of the reaction vessel 10 in the gravity action direction. The reaction solution 4 includes, for example, DNA (target nucleic acid) that is amplified by the PCR, enzymes such as DNA polymerase necessary for amplifying the DNA, primers, and fluorescent probes for detecting amplification products of nucleic acid.

A volume of the reaction solution 4 is, for example, 0.1 μL or more and 5 μL or less, preferably 1 μL or more and 2 μL or less. A ratio of a surface area to the volume of the reaction solution 4 is suppressed and a frictional resistance with the liquid 6 can be suppressed by making the volume of the reaction solution 4 to be 0.1 μL or more. Therefore, when the reaction vessel 10 is rotated, the reaction solution 4 can be smoothly moved in the liquid 6. Therefore, it is possible to control the reaction solution 4 to a desired temperature. On the other hand, it is possible to shorten a time required for a temperature change of the reaction solution 4 and to realize high-speed of the PCR by making the volume of the reaction solution 4 to be 5 μL or less. In addition, there is no need to increase a inner diameter L (see FIG. 3) of the reaction vessel 10 more than necessary and it contributes to downsizing of the device.

The liquid 6 is not mixed with the reaction solution 4, that is, is a not-mixed liquid. The liquid 6 has the specific gravity less than that of the reaction solution 4. The liquid 6 is, for example, dimethyl silicone oil, paraffin oil, and the like.

A material of the reaction vessel 10 is, for example, glass, polymer, metal, or the like. The reaction vessel 10 can be rotated around a rotation axis Q. As illustrated in FIG. 1, the reaction vessel 10 has a circular ring shape as viewed from the direction (extending direction of the rotation axis Q) of the rotation axis Q. As illustrated in FIG. 1, the reaction vessel 10 has an inner portion 10a and an outer portion 10b, and the inner portion 10a and the outer portion 10b are concentric circles around the rotation axis Q.

As illustrated in FIG. 3, a sectional shape of the reaction vessel 10 is, for example, circular. Therefore, it is possible to suppress moving of the reaction solution 4 in the direction of the rotation axis Q and when fluorescence of the reaction solution 4 is detected by the fluorescence detection section 50, it is possible to reduce variation of luminance of fluorescence. The inner diameter L of the reaction vessel 10 is, for example, 2 mm or more and 3 mm or less. Moreover, a sectional shape of the reaction vessel 10 is not particularly limited and may be a quadrangular shape.

The reaction vessel 10 has a flow path 12 through which the reaction solution 4 moves. As illustrated in FIG. 1, the flow path 12 has a circular ring shape when viewed from the direction of the rotation axis Q. The flow path 12 forms a ring.

As illustrated in FIG. 2, the reaction vessel 10 is provided with a lid 14 via an injection pipe 13. In the illustrated example, the injection pipe 13 is connected to the reaction vessel 10 and the lid 14 is provided in the injection pipe 13. The injection pipe 13 does not extend from the reaction vessel 10 in a direction facing an inside of the reaction vessel 10. That is, as illustrated in FIG. 1, the injection pipe 13 is spaced apart from the inner portion 10a when viewed from the direction of the rotation axis Q. In the example illustrated in FIG. 2, the injection pipe 13 extends from the reaction vessel 10 in the direction of the rotation axis Q. The injection pipe 13 is, for example, provided integrally with the reaction vessel 10. It is possible to inject the reaction solution 4 and the liquid 6 from the injection pipe 13 into the reaction vessel 10.

Moreover, although not illustrated, the injection pipe 13 may extend from the reaction vessel 10 in a direction facing an outside of the reaction vessel 10. Specifically, the injection pipe 13 may extend from the outer portion 10b in the direction facing the outside of the reaction vessel 10.

The first heating section 20 and the second heating section 22 are members for transmitting heat generated from a heater (not illustrated) to the reaction vessel 10. The heating sections 20 and 22 are, for example, connected to the reaction vessel 10. The heating sections 20 and 22 are, for example, provided by being spaced apart from each other.

The first heating section 20 and the second heating section 22 are, for example, aluminum heat blocks. It is possible to efficiently heat the reaction vessel 10 by making the heat block of aluminum. The heating sections 20 and 22 are composed of, for example, a heat block divided into two and the reaction vessel 10 is sandwiched by the heat block, and thereby the reaction vessel 10 is fixed to the heat block.

The first heating section 20 heats a first region 16 of the reaction vessel 10. The first region 16 is a region that is covered by the first heating section 20 of the reaction vessel 10. In the illustrated example, the first heating section 20 is provided with a first opening section 21 and the first region 16 is inserted into the first opening section 21. The first opening section 21 is a through-hole penetrating the first heating section 20.

The first heating section 20 is capable of heating the first region 16 to a first temperature. The first temperature is, for example, 92° C. or more and 97° C. or less, preferably 95° C. The first temperature is a temperature suitable for denaturation (dissociation of double-stranded DNA) in the PCR.

The second heating section 22 heats a second region 17 that is different from the first region 16 of the reaction vessel 10. The second region 17 is a region that is covered by the second heating section 22 of the reaction vessel 10. In the illustrated example, the second heating section 22 is provided with a second opening section 23 and the second region 17 is inserted into the second opening section 23. The second opening section 23 is a through-hole penetrating the second heating section 22.

The second heating section 22 is capable of heating the second region 17 to a second temperature different from the first temperature. The second temperature is lower than the first temperature and is, for example, 55° C. or more and 72° C. or less, preferably 60° C. The second temperature is a temperature suitable for annealing (reaction in which a primer binds to a single-stranded DNA) and extension reaction (reaction in which a complementary strand of DNA is formed with a primer as a starting point) in the PCR. In the example illustrated in FIG. 1, the reaction solution 4 is positioned within the second region 17.

The temperatures of the first heating section 20 and the second heating section 22 may be controlled by a temperature sensor (not illustrated) and the control section 40. The opening sections 21 and 23 respectively provided in the heating sections 20 and 22 are mounting sections capable of mounting the reaction vessel 10.

The drive mechanism 30 is a mechanism for switching the reaction vessel 10 and the heating sections 20 and 22 to a first disposition, a second disposition, and a third disposition (between the first disposition, the second disposition, and the third disposition). The drive mechanism 30 has a support section 32 that supports the reaction vessel 10 and a motor 34 that rotates the support section 32.

The drive mechanism 30 rotates (rotates in the clockwise direction in the example illustrated in FIG. 1) the support section 32 while maintaining a positional relationship between the reaction vessel 10 and the heating sections 20 and 22 around the rotation axis Q due to the drive of the motor 34. Therefore, the reaction vessel 10 and the heating sections 20 and 22 rotate while maintaining the positional relationship therebetween. The drive mechanism 30 rotates the reaction vessel 10 around the rotation axis (rotation axis extending in a direction perpendicular to the gravity action direction) Q having a component in a direction perpendicular to the gravity action direction. In the illustrated example, the support section 32 is connected to the reaction vessel 10 at two places and is connected to each of the heating sections 20 and 22 at one place. A rotational speed of the reaction vessel 10 is constant (specifically, constant except for the start and the end of the rotation), for example, during performing the PCR. The rotational speed of the reaction vessel 10 is, for example, a speed at which the reaction solution 4 always remains at the lowermost portion of the reaction vessel 10 in the gravity action direction.

Moreover, the rotational speed of the support section 32 may be changed with time. In addition, a shape of the support section 32 is not particularly limited as long as it can rotate the reaction vessel 10 and the heating sections 20 and 22 while maintaining the positional relationship each other.

The control section 40 controls the drive mechanism 30 such that the reaction vessel 10 and the heating sections 20 and 22 repeat the first disposition and the second disposition a predetermined number of times. The control section 40 is configured, for example, to include a Central Processing Unit (CPU), a Read Only Memory (ROM), and a Random Access Memory (RAM). A storage section stores, for example, various programs for controlling the drive mechanism 30, data, and the like. The storage section temporarily stores data in processing, processed results, and the like of various processes performed by the control section 40.

The fluorescence detection section 50 irradiates light to the reaction solution 4 and detects fluorescence (fluorescence of the reaction solution 4) emitted from the reaction solution 4, for example, using the control of the control section 40. The fluorescence detection section 50 is provided in a position in which the lowermost portion of the reaction vessel 10 in the gravity action direction is irradiated with light. The fluorescence detection section 50 can irradiate the reaction solution 4 with light when a third region 18 that is not covered by the heating sections 20 and 22 of the reaction vessel 10 is positioned in the lowermost portion of the reaction vessel 10 in the gravity action direction. The fluorescence detection section 50 may continue emitting light during performing the PCR. The third region 18 is, for example, a region (region in which the lid 14 is not provided in the example illustrated in FIG. 1) which is not covered by the heating sections 20 and 22 of the reaction vessel 10, and is a region that is positioned in the lowermost portion after the second region 17 is positioned the lowermost portion of the reaction vessel 10 in the gravity direction and before the first region 16 is positioned in the lowermost portion in a case where the drive mechanism 30 is driven.

The detection results of the fluorescence detection section 50 may be stored in the storage section of the control section 40. The control section 40 obtains, for example, an amplification curve of nucleic acid of the PCR and determines the number of times of the temperature cycles of the PCR based on luminance (fluorescence luminance) of fluorescence detected by the fluorescence detection section 50. The fluorescence detection section 50 is fixed without being rotated by the drive mechanism 30.

### 1.2. Thermal Cycle Method

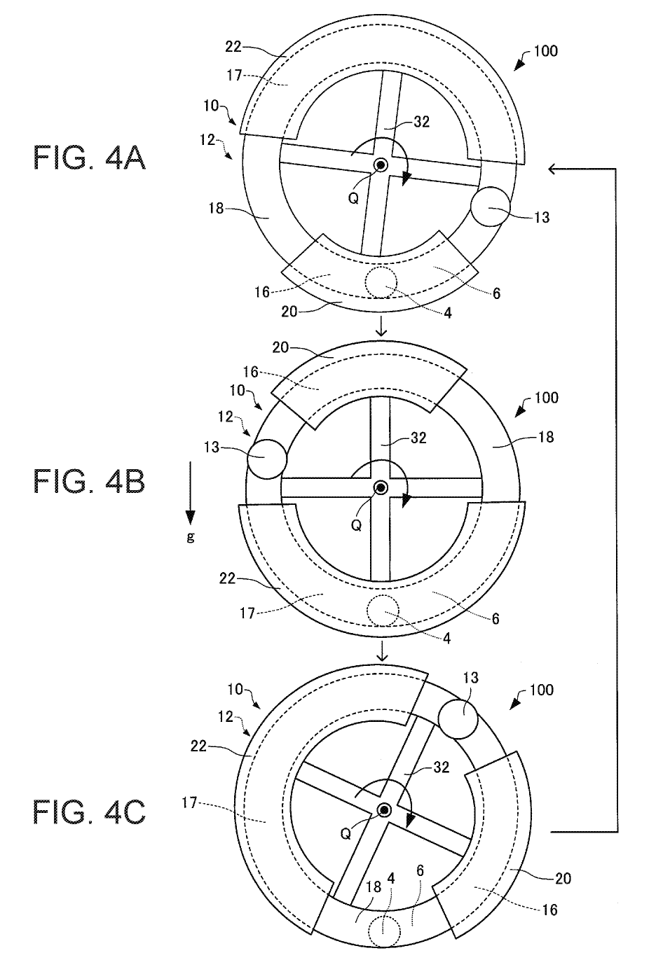

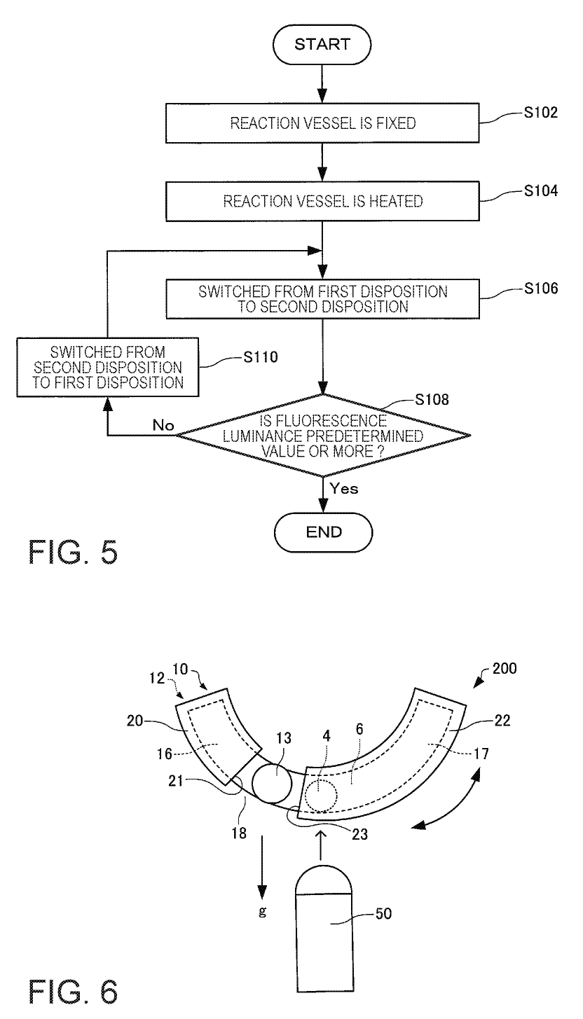

FIGS. 4A-4C are schematic views describing a thermal cycle method using the thermal cycle device 100. FIG. 5 is a flow chart describing the thermal cycle method using the thermal cycle device 100. Moreover, for the sake of convenience, the drive mechanism 30, the control section 40, and the fluorescence detection section 50 are not illustrated in FIGS. 4A-4C.

First, the reaction vessel 10 filled with the reaction solution 4 and the liquid 6 is fixed to the heating sections 20 and 22 (step S102). For example, the reaction vessel 10 is fixed to the heating sections 20 and 22 by being sandwiched between the heat blocks.

In step S102, disposition of the reaction vessel 10 and the heating sections 20 and 22 is the first disposition (see FIG. 4A). As illustrated in FIG. 4A, the first disposition is a disposition in which the first region 16 is in the lowermost portion of the reaction vessel 10 in the gravity action direction. Therefore, the reaction solution 4 having the specific gravity greater than that of the liquid 6 is positioned within the first region 16.

Next, the reaction vessel 10 is heated by the heating sections 20 and 22 (step S104). Specifically, the first heating section 20 heats the first region 16 of the reaction vessel 10 to the first temperature. The second heating section 22 heats the second region 17 of the reaction vessel 10 to the second temperature. Therefore, a temperature gradient is formed such that a temperature decreases from the inside of the first region 16 to the inside of the second region 17.

In step S104, since the disposition of the reaction vessel 10 and the heating sections 20 and 22 is the first disposition, the reaction solution 4 is heated to the first temperature. Therefore, in step S104, reaction (denaturation) with respect to the reaction solution 4 in the first temperature is performed.

Next, the control section 40 controls the drive mechanism 30 and switches the reaction vessel 10 from the first disposition to the second disposition (step S106). Specifically, the control section 40 controls the drive mechanism 30, rotates the reaction vessel 10, and switches the reaction vessel 10 from the first disposition to the second disposition. In the embodiment, in a case where step S106 is performed following step S104, that is, when step S106 is firstly performed, the control section 40 switches the reaction vessel 10 from the first disposition to the second disposition in a case where the temperature sensor (not illustrated) (temperature sensor connected to the first heating section 20) determines that a predetermined time is elapsed after reaching a predetermined temperature. The reaction solution 4 having the specific gravity greater than that of the liquid 6 is turned within the reaction vessel 10 and is, for example, always positioned in the lowermost portion of the reaction vessel 10 during the rotation of the reaction vessel 10.

As illustrated in FIG. 4B, the second disposition is a disposition in which the second region 17 is in the lowermost portion of the reaction vessel 10 in the gravity action direction. Therefore, the reaction solution 4 is positioned within the second region 17. The reaction solution 4 is heated to the second temperature and reaction (annealing and the extension reaction) is performed to the reaction solution 4 in the second temperature during the second disposition (during the reaction solution 4 passes through the inside of the second region 17).

Next, the control section 40 determines whether or not the detected fluorescence luminance is a predetermined value or more (step S108). Specifically, as illustrated in FIG. 4C, the control section 40 obtains the fluorescence luminance (fluorescence luminance of the reaction solution 4) detected in the fluorescence detection section 50 in the third disposition in which the third region 18 is in the lowermost portion of the reaction vessel 10 in the gravity action direction. Therefore, the control section 40 determines whether or not the obtained fluorescence luminance is a predetermined value or more that is stored in the storage section in advance.

In step S108, in a case where it is determined that the fluorescence luminance detected by the control section 40 is the predetermined value or more (Yes), the control section 40 controls the drive mechanism 30, stops the drive of the motor 34, and completes the process (END). In a case where the fluorescence luminance detected by the control section 40 is less than the predetermined value (No), the process proceeds to step S110.

In a case of No in step S108, the control section 40 continues to drive the motor 34 and switches the reaction vessel 10 from the second disposition to the first disposition (step S110). Therefore, the reaction vessel 10 is in a state (first disposition) illustrated in FIG. 4A.

Next, step S106 is started again.

Moreover, the first temperature, the second temperature, the rotational speed of the support section 32, sizes of the heating sections 20 and 22, and the like are appropriately determined in consideration of types and amounts of the reaction solution 4 and the liquid 6, a size of the reaction vessel 10, and the like.

For example, in a case where the first heating section 20 covers ¼ of the surface of the reaction vessel 10, the second heating section 22 covers ½ of the surface of the reaction vessel 10, and the reaction vessel 10 rotates at a rate of one revolution in 5 seconds, a temperature cycle of 1.25 seconds at the first temperature and 2.5 seconds at the second temperature can be applied to the reaction solution 4 at one revolution. For example, it is possible to complete the PCR by performing the temperature cycle for 40 rotations (40 cycles) or more. For example, in a case where the temperature cycle is performed for 40 cycles, it is possible to realize the PCR (high-speed PCR) in a short period of time of 3 minutes and 20 seconds.

The thermal cycle device 100 has, for example, the following features.

In the thermal cycle device 100, the reaction vessel 10 has the flow path 12 through which the reaction solution 4 moves and which forms a circular ring. Therefore, in the thermal cycle device 100, it is possible to apply the temperature cycles to the reaction solution 4 only by rotating the reaction vessel 10. Therefore, in the thermal cycle device 100, even if the number of times of the temperature cycles that are applied is increased, the device does not become large and it is possible to achieve downsizing of the device.

Furthermore, in the thermal cycle device 100, the reaction vessel 10 is rotated at a constant speed by appropriately setting the sizes of the heating sections 20 and 22. Therefore, it is possible to apply a desired temperature cycle to the reaction solution 4. Furthermore, in the thermal cycle device 100, it is possible to easily control the drive mechanism 30.

In the thermal cycle device 100, the reaction vessel 10 is filled with the reaction solution 4 and the liquid 6 that is not mixed with the reaction solution 4. Therefore, in the thermal cycle device 100, it is possible to hold the reaction solution 4 in a droplet state in the liquid 6.

In the thermal cycle device 100, the specific gravity of the reaction solution 4 is greater than the specific gravity of the liquid 6. Therefore, the reaction solution 4 can be always positioned in the lowermost portion of the reaction vessel 10 in the gravity action direction. Therefore, in the thermal cycle device 100, for example, even if the air bubbles are mixed within the reaction vessel 10 when injecting the liquid 6 or the like, the air bubbles having the specific gravity less than that of the liquid 6 is moved to the uppermost portion of the reaction vessel 10 in the gravity action direction. Therefore, it is possible to reduce possibility that the reaction solution 4 comes into contact with the air bubbles. Therefore, in the thermal cycle device 100, it is possible to suppress inhibition of the PCR due to the air bubbles.

In the thermal cycle device 100, the second heating section 22 capable of heating the second region 17 to the second temperature different from the first temperature is provided. Therefore, in the thermal cycle device 100, it is possible to heat the first region 16 of the reaction vessel 10 to a temperature suitable for denaturation and to heat the second region 17 of the reaction vessel 10 to a temperature suitable for annealing and the extension reaction.

In the thermal cycle device 100, the fluorescence detection section 50 that detects fluorescence of the reaction solution 4 is provided. Therefore, in the thermal cycle device 100, it is possible to determine the number of times of the temperature cycles of the PCR based on the detection results of the fluorescence detection section 50.

In the thermal cycle device 100, the drive mechanism 30 rotates the reaction vessel 10 around the rotation axis Q having a component of a direction perpendicular to the gravity action direction. Therefore, in the thermal cycle device 100, it is possible to move the reaction solution 4 by using gravity.

In the thermal cycle device 100, the reaction solution 4 contains nucleic acid. Therefore, in the thermal cycle device 100, it is possible to amplify nucleic acid by the PCR.

Moreover, although not illustrated, the thermal cycle device 100 may include a third heating section capable of heating the reaction vessel 10 to a third temperature different from the first temperature and the second temperature. The third temperature is, for example, a temperature lower than the first temperature and higher than the second temperature. Specifically, the third temperature is 70° C. or more and 75° C. or less. Therefore, the second temperature is a temperature suitable for annealing and the third temperature is a temperature suitable for the extension reaction. As described above, it is possible to perform annealing and the extension reaction at different temperatures and it is possible to optimize the PCR.

As described above, in the thermal cycle device 100, since the shapes of the reaction vessel 10 and the flow path are the circular rings, a degree of freedom of the temperature distribution is high. For example, it is possible to heat the reaction vessel by three heating sections with a simple structure by providing three heating sections along the reaction vessel 10. Moreover, the number of heating sections may be four or more.

### 2. Modification examples of Thermal Cycle Device

### 2.1. First Modification Example

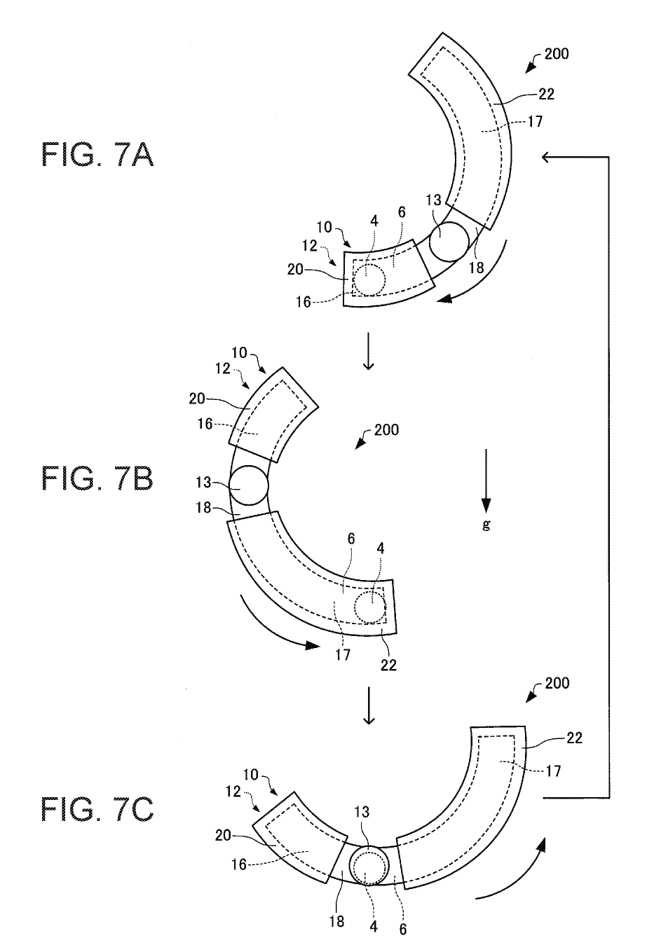

Next, a thermal cycle device according to a first modification example of the embodiment will be described with reference to the drawings. FIG. 6 is a front view schematically illustrating a thermal cycle device 200 according to the first modification example of the embodiment. FIGS. 7A-7C are schematic views describing a thermal cycle method using the thermal cycle device 200 according to the first modification example of the embodiment. Moreover, for the sake of convenience, a drive mechanism 30 and a control section 40 are not illustrated in FIG. 6. In addition, the drive mechanism 30, the control section 40, and a fluorescence detection section 50 are not illustrated in FIGS. 7A-7C.

Hereinafter, in the thermal cycle device 200 according to the first modification example of the embodiment, the same reference numerals are given to members having the same functions as the configuration members of the thermal cycle device 100 according to the embodiment described above and detailed description will be omitted. This also applies to a thermal cycle device according to a second modification example of the embodiment described below.

In the thermal cycle device 100 described above, as illustrated in FIG. 1, the reaction vessel 10 and the flow path 12 have the circular ring shapes. In contrast, in the thermal cycle device 200, as illustrated in FIG. 6, a reaction vessel 10 and a flow path 12 have a shape of a part of the circular ring. In other words, the reaction vessel 10 and the flow path 12 have shapes (in the illustrated example, shapes obtained by cutting more than half of the circular ring) obtained by cutting off a part of the circular ring. The flow path 12 forms a part of the circular ring.

In the example illustrated in FIG. 6, a first opening section 21 is a hole having a bottom provided in a first heating section 20. A second opening section 23 is a hole having a bottom provided in a second heating section 22.

The drive mechanism 30 reciprocates the reaction vessel 10 and the heating sections 20 and 22 so that the reaction solution 4 moves from one end to the other end of the flow path 12. One reciprocation time is, for example, approximately 10 seconds. One reciprocation time is, for example, constant during performing the PCR. Moreover, one reciprocation time may be changed with time.

In the thermal cycle device 200, as illustrated in FIG. 7A, in a first disposition, the reaction solution 4 is positioned within the first region 16 and reaction (denaturation) is performed to the reaction solution 4 in the first temperature. As illustrated in FIG. 7B, in a second disposition, the reaction solution 4 is positioned within the second region 17 and reaction (annealing and extension reaction) is performed to the reaction solution 4 in the second temperature. As illustrated in FIG. 7C, in a third disposition, the control section 40 obtains luminance of fluorescence (fluorescence of the reaction solution 4) detected in the fluorescence detection section 50. In the illustrated example, the third region 18 is a region in which a lid 14 is provided.

In the thermal cycle device 200, since the flow path 12 forms a part of the circular ring, it is possible to reduce the reaction vessel 10 in size compared to a case where the flow path 12 is the circular ring. Therefore, in the thermal cycle device 200, it is possible to achieve further downsizing of the device.

### 2.2. Second Modification Example

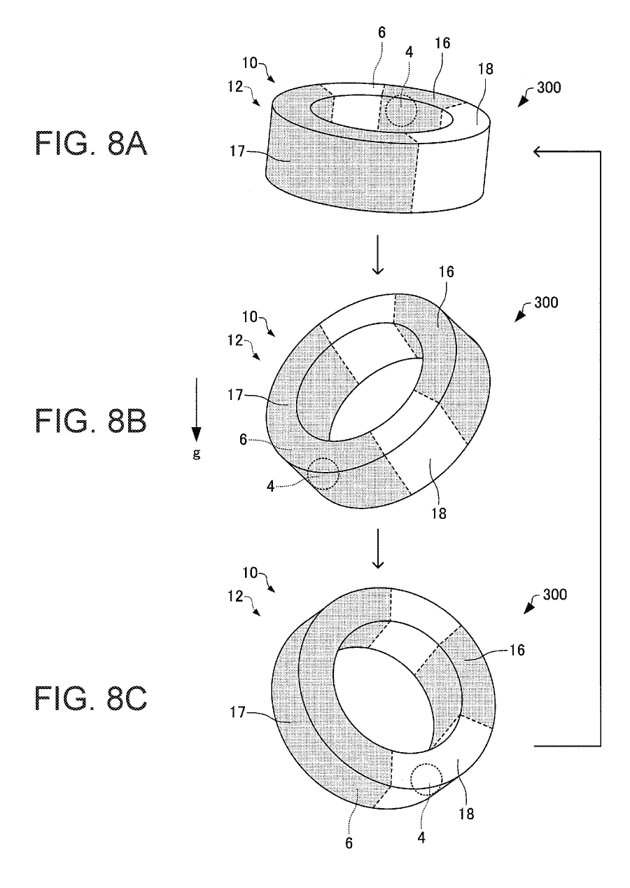

Next, a thermal cycle device according to a second modification example of the embodiment will be described with reference to the drawings. FIGS. 8A-8C are schematic views describing a thermal cycle method using a thermal cycle device 300 according to a second modification example of the embodiment. Moreover, for the sake of convenience, an injection pipe 13, a lid 14, heating sections 20 and 22, a drive mechanism 30, a control section 40, and a fluorescence detection section 50 are not illustrated in FIGS. 8A-8C.

In the thermal cycle device 100 described above, as illustrated in FIGS. 4A-4C, the drive mechanism 30 rotates the reaction vessel 10 and switches the reaction vessel 10 to the first to third dispositions. In contrast, in the thermal cycle device 300, as illustrated in FIGS. 8A-8C, the drive mechanism 30 processes the reaction vessel 10 and switches the reaction vessel 10 to the first to third dispositions. In other words, the drive mechanism 30 operates the reaction vessel 10 and switches the reaction vessel 10 to the first to third dispositions so that a rotation shaft (not illustrated) of the reaction vessel 10 draws a circle.

In the thermal cycle device 300, as illustrated in FIG. 8A, in the first disposition, the reaction solution 4 is positioned within the first region 16 and reaction (denaturation) is performed to the reaction solution 4 in the first temperature. As illustrated in FIG. 8B, in the second disposition, the reaction solution 4 is positioned within the second region 17 and reaction (annealing and extension reaction) is performed to the reaction solution 4 in the second temperature. As illustrated in FIG. 8C, in the third disposition, the control section 40 obtains luminance of fluorescence (fluorescence of the reaction solution 4) detected in the fluorescence detection section 50.

In the thermal cycle device 300, the drive mechanism 30 precesses the reaction vessel 10. Therefore, in the thermal cycle device 300, the reaction vessel 10 and the heating sections 20 and 22 are not rotated. Therefore, in the thermal cycle device 300, it is possible to reduce possibility that wiring for heating the heating sections 20 and 22 is twisted and it is possible to facilitate wiring routing without using a contact point compared to a case where the reaction vessel 10 and the heating sections 20 and 22 are rotated. Therefore, in the thermal cycle device 300, it is possible to improve reliability and durability.

Moreover, in the example illustrated in FIGS. 8A-8C, a sectional shape of the reaction vessel 10 is a quadrangular shape, but may be a circular shape as illustrated in FIG. 3.

The invention may omit a part of configuration within a range having the features and effects described in this application, or may combine each embodiment and modification example.

The invention includes a configuration substantially the same (for example, same configuration in function, method, and result, or same configuration in object and effect) as that described in the embodiments. In addition, the invention includes a configuration in which non-essential portions of the configuration described in the embodiments are replaced. In addition, the invention includes a configuration that achieves the same operation and effect as the configuration described in the embodiments, or a configuration that can achieve the same object. In addition, the invention includes a configuration in which a known technique is added to the configuration described in the embodiments.

What is claimed is:

1. A thermal cycle device comprising:
a mounting section capable of mounting a reaction vessel having a flow path that forms a circular ring or a part of a circular ring in which a reaction solution moves;
a first heating section capable of heating a first region of the reaction vessel to a first temperature; and
a drive mechanism that switches the reaction vessel between a first disposition and a second disposition,
wherein the first disposition is a disposition in which the first region is the lowermost portion of the reaction vessel in a direction in which gravity acts, and
wherein the second disposition is a disposition in which a second region different from the first region of the reaction vessel is the lowermost portion of the reaction vessel in the direction in which gravity acts.

2. The thermal cycle device according to claim 1,
wherein the reaction vessel is filled with the reaction solution and a liquid immiscible with the reaction solution.

3. The thermal cycle device according to claim 2,
wherein a specific gravity of the reaction solution is greater than a specific gravity of the liquid.

4. The thermal cycle device according to claim 1, further comprising:
a second heating section capable of heating the second region to a second temperature different from the first temperature.

5. The thermal cycle device according to claim 1, further comprising:
a fluorescence detection section that detects fluorescence of the reaction solution.

6. The thermal cycle device according to claim 1,
wherein the drive mechanism rotates the reaction vessel around a rotation axis having a component in a direction perpendicular to a direction in which gravity acts.

7. The thermal cycle device according to claim 1,
wherein the drive mechanism precesses the reaction vessel.

8. The thermal cycle device according to claim 1,
wherein the reaction solution contains nucleic acid.

9. A thermal cycle method comprising:
switching a reaction vessel having a flow path that forms a circular ring or a part of a circular ring in which a reaction solution moves from a first disposition to a second disposition; and
switching the reaction vessel from the second disposition to the first disposition,
wherein the first disposition is a disposition in which a first region of the reaction vessel is the lowermost portion of the reaction vessel in a direction in which gravity acts, and
wherein the second disposition is a disposition in which a second region different from the first region of the reaction vessel is the lowermost portion of the reaction vessel in the direction in which gravity acts.
